(19) United States
(12) Patent Application Publication
(10) Pub. No.: US 2008/0196458 A1
(43) Pub. Date: Aug. 21, 2008

(54) KEYHOLELESS LOCK DEVICE

(76) Inventor: Chi Feng LU, Taipei City (TW)

Correspondence Address: SINORICA, LLC, 528 FALLSGROVE DRIVE, ROCKVILLE, MD, 20850, US

(21) Appl. No.: 11/675,675

(22) Filed: Feb. 16, 2007

(51) Int. Cl. E05B 65/12; B60R 25/04

(52) U.S. Cl. 70/257

(57) ABSTRACT

The present invention discloses a keyholeless lock device, which comprises a lock casing, a motor, an induction antenna, a circuit board, a control chip, a lock handle and a latch bolt. When the user is inside door, he may rotate the lock handle to open the door. When the user is outside the door, he has to use an induction key to open the door. The induction key can send out encryption information to the induction antenna, and the control chip uses a decryption procedure to judge whether the induction key is authentic. If the induction key is authentic, the motor will retract the latch bolt into the lock casing. When there is a power failure, the induction key will be inserted into the lock casing and function as the power source of the induction antenna, the circuit board and the control chip. As the keyholeless lock device of the present invention abolishes the traditional keyhole and lock cylinder, thieves are unlikely to burglar with their lock-picking skill. Therefore, the keyholeless lock device of the present invention is a high-reliability security device.

### BACKGROUND OF THE INVENTION

1. Field of the Invention

The present invention relates to a lock device, particularly to a keyholeless and cylinderless lock device.

2. Description of the Related Art

The locksmiths and lock manufacturers usually pay attention to improving the lock cylinder to prevent thieves from fast unlocking the door. However, the thieves nowadays have sophisticated lock-picking skill. Further, the lockpicks are available everywhere. Therefore, even the precision lock cylinders can no more prevent from theft. Thus, how to invalidate the lock-picking skill and tools and protect the lives and wealth of people is a serious subject.

The locks sold in the market usually emphasize that the lock cylinders thereof are so unique and sophisticated that even the most skilled thief is unlikely to open the lock within a short time. However, unlocking a lock is only a problem of time for a thief. In fact, no conventional lock can guarantee that a thief will never enter the house. There are also electric locks sold in the market, such as the NC (Normally Closed) rated electric lock and the electromagnetic lock. However, these electric locks have the problem—the lock opens automatically or cannot be unlocked during a power failure. For example, the NC rated electric lock will remain unlocked until power is restored. Therefore, a traditional lock is needed to prevent the door from remaining unlocked during a power failure. Such an extra lock usually results in inconvenient unlocking operation or a soft spot for thieves.

Accordingly, the present invention proposes a keyholeless lock device to overcome the abovementioned problems.

### SUMMARY OF THE INVENTION

The primary objective of the present invention is to provide a keyholeless lock device, which provides a lock handle to open the door from the inside and provides an induction key to open the door from the outside, and which abolishes the lock cylinder lest thieves unlock the door with their lock-picking skill.

Another objective of the present invention is to provide a keyholeless lock device, wherein an induction key intercommunicates with the circuit device inside the lock casing, and an encryption algorithm is used to identify the induction key; if the induction key is authentic, a motor retracts the latch bolt to open the door.

Yet another objective of the present invention is to provide a keyholeless lock device, wherein the induction key thereof can function as a power source to power the circuit device inside the lock casing during a power failure.

Further another objective of the present invention is to provide a keyholeless lock device, wherein a cryptographic algorithm and an radio frequency identification transmission technology are used to identify whether the induction key is authentic.

To achieve the abovementioned objectives, the present invention proposes a keyholeless lock device, which comprises a lock casing, a rotary lock handle arranged on one surface of the lock casing, a latch bolt arranged on one edge of the lock casing, an induction key used to send out an encryption information, a circuit device arranged inside the lock casing, and a motor arranged inside the lock casing, wherein the circuit device receives the encryption information output by the induction key and uses a decryption procedure to identify whether the induction key is authentic; if the induction key is authentic, the circuit device drives the motor to retract the latch bolt into the lock casing to open the door. The keyholeless lock device of the present invention provides two door-opening means: one means is a rotary lock handle to open the door from the inside, and the other is an induction key to open the door from the outside with encryption and decryption algorithms identifying whether the induction key is authentic. Therefore, the keyholeless lock device of the present invention is a high-reliability security device.

To enable the objectives, technical contents, characteristics and accomplishments of the present invention to be easily understood, the embodiments of the present invention are to be described in detail below.

### BRIEF DESCRIPTION OF THE DRAWINGS

FIG. 1 is a perspective view schematically showing the keyholeless lock device according to the present invention;

FIG. 2 is a sectional view schematically showing the keyholeless lock device according to the present invention;

FIG. 3 is a diagram schematically showing the structure of the circuit board, induction antenna and control chip of the keyholeless lock device according to the present invention; and

FIG. 4 is a diagram schematically showing that an induction key unlocks the door from the outside according to the present invention.

### DETAILED DESCRIPTION OF THE INVENTION

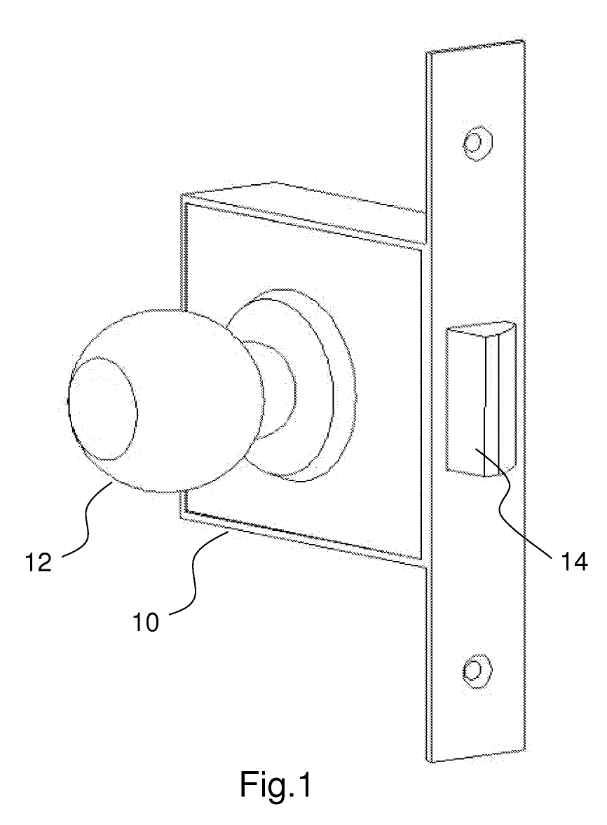

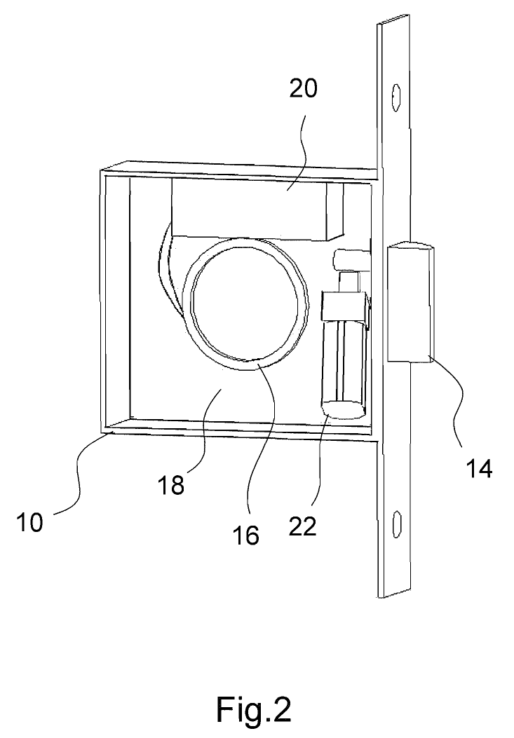

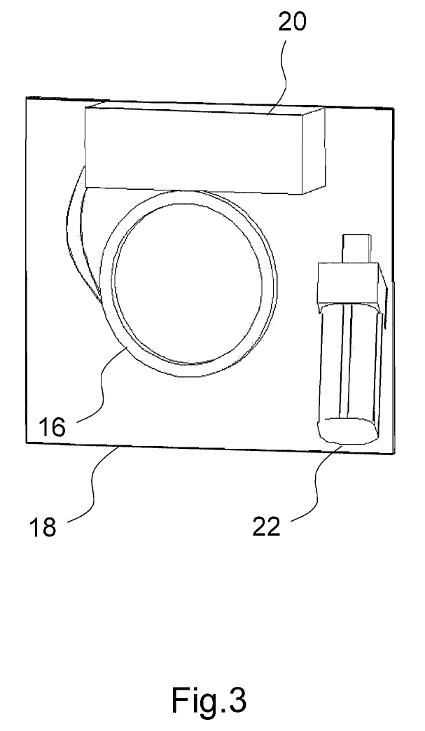

The present invention pertains to a keyholeless lock device, which abolishes the traditional keyhole and lock cylinder. Refer to FIG. 1 and FIG. 2. The keyholeless lock device of the present invention comprises a lock casing 10, a lock knob 12 arranged on the indoors-facing surface of the lock casing 10, and a retractable latch bolt 14. The keyholeless lock device of the present invention also comprises an induction antenna 16, a circuit board 18, a control chip 20 and a motor 22, which are all arranged inside the lock casing 10. Refer to FIG. 3. The circuit board 18 is disposed on the bottom of the lock casing 10, and the induction antenna 16, the control chip 20 and the motor 22 are electrically connected to the circuit board 18.

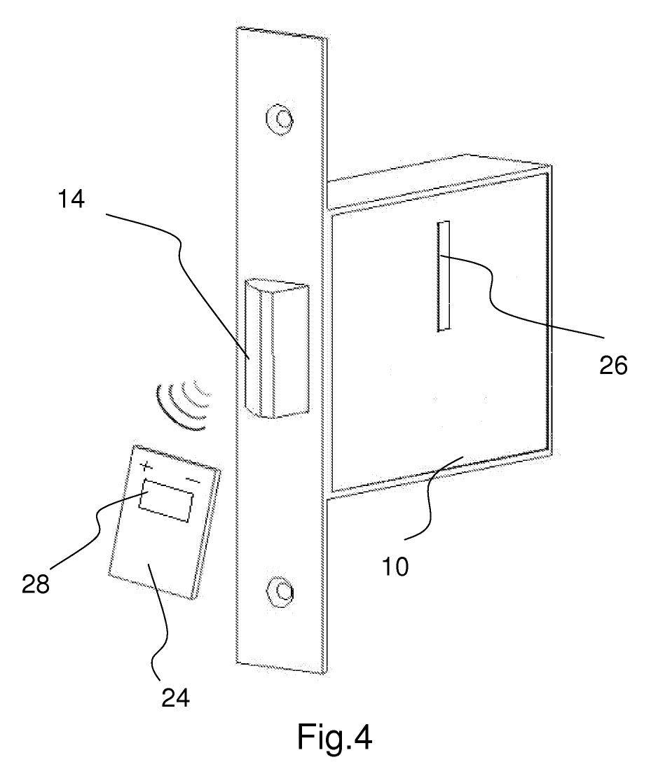

The present invention is characterized in that different means are respectively used to unlock the door from the inside and the outside. When the user is inside the door, he rotates the lock knob 12 to drive the motor 22 to retract the latch bolt 14 into the lock casing 10 to open the door. The keyholeless lock device of the present invention has none traditional keyhole and lock cylinder. When the user is outside the door, he uses a non-contact induction means to open the door. Refer to FIG. 4. The keyholeless lock device of the present invention also comprises an induction key 24, which can use radio frequency identification transmission technology to intercommunicate with the induction antenna 16. The secret key inside the induction key 24 utilizes a symmetric or asymmetric cryptographic algorithm to encrypt random numbers. Then, the induction key 24 sends out the encryption information and the data of the random numbers. The induction antenna 16 receives the encryption information and the data of the random numbers and transfers them to the control chip 20. The control chip 20 encrypts the random numbers with the secret key inside the control chip 20 and compares the result with the encryption information output by the induction key 24. If they match, it means that the induction key 24 is authentic, and the control chip 20 instantly controls the motor 22 to rotate to retract the latch bolt 14 into the lock casing 10 to open the door.

Normally, the keyholeless lock device of the present invention is powered by commercial power. When commercial power is interrupted, the user inside the door can till open the door via rotating the lock knob 12 to retract the latch bolt 14. However, the user outside the door can no more use the induction key 24 to open the door in the normal way. At this time, the induction key 24 of the present invention can function as a standby power supply. The user can engage the induction key 24 with the lock casing 10 to power the lock device. After the induction key 24 is authenticated, the latch bolt 14 is retracted into the lock casing 10 to open the door.

In summary, the keyholeless lock device of the present invention can apply to various doors. Owing to the characteristics of none keyhole and none lock cylinder, the keyholeless lock device of the present invention can prevent thieves from unlocking the door with their lock-picking skill. The keyholeless lock device of the present invention possesses two means to respectively open the lock from the inside and the outside. When the user is inside door, he rotates the lock knob to open the door. When the user is outside the door, he uses an induction key to open the door. Further, the induction key can function as a standby power supply. When there is a power failure, the user inside the door can still rotate the lock knob to open the door, and the user outside the door can use the induction key to power the lock device and then attain the authentication to open the door. Therefore, the present invention not only has the characteristics of none keyhole and none lock cylinder but also can prevent the user from being unable to open the lock during a power failure.

Those described above are the preferred embodiments to exemplify the present invention. However, it is not intended to limit the scope of the present invention. Any equivalent modification and variation according to the spirit of the present invention is to be also included within the scope the claims of the present invention.

1. A keyholeless lock device, comprising the following components:
a lock casing having a rotary lock handle on one surface thereof and having a retractable latch bolt on one edge thereof;
an induction key able to output an encryption information;
a circuit device arranged inside said lock casing, used to receive said encryption information output by said induction key, utilizing a decryption procedure to identify whether said induction key is authentic, and driving a motor to retract said latch bolt into said lock casing to open a door if said induction key is authentic;
said circuit device further comprises a circuit board, an induction antenna, and a control chip: and
said control chip uses encryption and decryption procedures of a secret key to identify whether said induction key is authentic by comparing the result of encryption and decryption procedure with the received encryption information sent from the induction key, if said induction key is authentic, said control chip drives said motor to retract said latch bolt, wherein
the secret key encrypts random numbers by a symmetric or asymmetric cryptographic algorithm.

2. The keyholeless lock device according to claim 1, wherein said lock handle is a rotary lock knob.

3. (canceled)

4. (canceled)

5. (canceled)

6. The keyholeless lock device according to claim 1, wherein said circuit device is normally powered by commercial power.

7. The keyholeless lock device according to claim 1, wherein said induction key further comprises a standby power supply; when there is a power failure, said induction key is engaged with said lock casing to power said circuit device and said motor.

8. The keyholeless lock device according to claim 1, wherein said induction antenna intercommunicates with said induction key via electromagnetic waves.

9. The keyholeless lock device according to claim 1, wherein said circuit board is disposed on bottom of said lock casing.

10. The keyholeless lock device according to claim 1, wherein user outside the door uses said induction key to attain an authentication from said circuit device and then unlock the door.
